(19) United States
(12) Patent Application Publication
(10) Pub. No.: US 2002/0120055 A1
(43) Pub. Date: Aug. 29, 2002

(54) Adhesive mixtures of hydroxyl-or carboxyl-group-containing solution rubbers

(76) Inventors: Thomas Scholl, Bergisch Gladbach (DE); Ulrike Ilse Scholl, Bergisch Gladbach (DE); Philipp Scholl, Bergisch Gladbach (DE); Christine Scholl, Bergisch Gladbach (DE); Johannes Scholl, Bergisch Gladbach (DE); Jurgen Trimbach, Koln (DE); Wolfgang Nentwig, Bergisch Gladbach (DE); Rudiger Engehausen, Dormagen (DE)

Correspondence Address: BAYER CORPORATION, PATENT DEPARTMENT, 100 BAYER ROAD, PITTSBURGH, PA, 15205, US

(21) Appl. No.: 09/972,494

(22) Filed: Oct. 5, 2001

(30) Foreign Application Priority Data
Oct. 10, 2000 (DE) 10049964.3

(51) Int. Cl. C08K 3/00

(52) U.S. Cl. 524/543; 524/570

(57) ABSTRACT

The present invention relates to adhesive rubber mixtures consisting of at least one rubber and from 5 to 300 parts by weight of filler, the rubber having been prepared by polymerizing diolefins and, optionally, further vinylaromatic monomers in solution and introducing hydroxyl and/or carboxyl groups, that rubber having a total content of from 0.05 to 5 wt. % of bonded hydroxyl and/or carboxyl groups or their salts, a content of vinylaromatic monomers polymerized therein of from 0 to 50 wt. % and a content of diolefins of from 45 to 99.95 wt. %, the content of 1,2-bonded diolefins (vinyl content) being from 0 to 60 wt. % and the content of trans-1,4-bonded diolefin being from 0 to 40 wt. %, and from 2 to 20 parts by weight of sulfur or sulfur donors and, optionally, further rubbers, rubber auxiliaries and crosslinking agents. The rubber mixtures according to the present invention and their vulcanates are suitable for the production of rubber/steel cord composite vulcanates having high strength and hydrolytic stability, especially steel-cord-reinforced tires.

### FIELD OF THE INVENTION

The present invention relates to rubber mixtures that have especially good adhesion to reinforcing materials, especially steel cord, and contain particular hydroxyl- and/or carboxyl-group-containing solution diene rubbers, filler and from 2 to 20 parts by weight of sulfur or sulfur donors per 100 parts by weight of rubber and, optionally, further rubbers and rubber auxiliaries, and to the use thereof in the production of rubber/metal composite vulcanates having improved mechanical strength and higher hydrolytic stability. The rubber mixtures and vulcanates are suitable for the production of highly reinforced rubber molded bodies, especially steel-cord-reinforced tires and steel-cord-reinforced technical rubber articles, that can be subjected to especially high thermal, hydrolytic and mechanical loads.

### BACKGROUND OF THE INVENTION

The production of steel-cord-reinforced rubber articles, such as, for example, steel cord radial tires or conveyor belts, requires rubber mixtures and vulcanates having especially high rubber/metal adhesion and high hydrolytic stability. To that end, a number of possible solutions have been proposed. These are especially the addition of cobalt salts, combinations of resorcinol/formaldehyde donors/silica (RFK process), there being used as formaldehyde donors, for example, hexamethylenetetramine or melamine methylol ether, and also the addition of boric esters. Such systems are described, for example, in Ullmann, Encyklopadie der technischen Chemie, Verlag Chemie, Weinheim 1977, Volume 13, page 662 to 664, and in Rubber Chem. Technol. 1991, 64 (2), 285-295, and in Kautschuk, Gummi, Kunstst. 1990, 43(5), 385-387. It is a disadvantage that, in order to achieve especially high hydrolytic stability, the addition of ecologically disadvantageous cobalt salts is necessary.

U.S. Pat. No. 4,272,419 describes rubber mixtures of carboxylated emulsion SBR rubber that have improved adhesiveness to other rubbers and towards metal. No mention is made of an improvement in the properties of the vulcanates, especially with respect to improved hydrolytic stability of steel cord/rubber composite vulcanates. Moreover, emulsion SBR rubbers differ from the corresponding solution SBR rubbers in their molecular branching, cis/trans content, vinyl content etc., resulting in different vulcanate properties.

German patent applications EP-A 974,616 and EP-A 1,000,971 describe hydroxyl- and/or carboxyl-group-containing solution rubbers having an advantageous content (from 0.1 to 3 wt. %) of hydroxyl and/or carboxyl groups. However, the patent applications give no indication of improved steel cord/rubber composite systems. The rubbers mentioned therein are, moreover, crosslinked with only small amounts of sulfur (from 0.5 to 2 phr), such as are customarily used for the production of tire treads.

### SUMMARY OF THE INVENTION

Accordingly, it was an object of the present invention to provide rubber mixtures having especially good adhesion to metal, especially steel cord, from which mixtures rubber/metal composite vulcanates having especially high strength and hydrolytic stability can be produced.

Surprisingly, it has now been found that rubber/steel cord composite vulcanates having especially high cord thread adhesion, high tear-growth resistance, low dynamic damping and especially high hydrolytic stability can be produced from rubber mixtures containing diene rubbers that have been prepared in solution and have a particular content of hydroxyl and/or carboxyl groups, fillers and from 2 to 20 parts by weight of sulfur or sulfur donors, based on 100 parts by weight of rubber.

### DETAILED DESCRIPTION OF THE INVENTION

Accordingly, the present invention provides adhesive rubber mixtures for the production of rubber/steel cord composite vulcanates, comprising at least one rubber and from 5 to 300 parts by weight of filler, the rubber having been prepared by polymerizing diolefins and, optionally, further vinylaromatic monomers in solution and introducing hydroxyl and/or carboxyl groups, that rubber having a total content of from 0.05 to 5 wt. % of bonded hydroxyl and/or carboxyl groups or their salts, a content of vinylaromatic monomers polymerized therein of from 0 to 50 wt. %, and a content of diolefins of from 45 to 99.95 wt. %, the content of 1,2-bonded diolefins (vinyl content) being from 0 to 60 wt. % and the content of trans-1,4-bonded diolefin being from 0 to 40 wt. %, from 2 to 20 parts by weight of sulfur or sulfur donors, and, optionally, further rubbers, rubber auxiliaries and crosslinking agents, the indicated parts by weight of filler and sulfur being based on 100 parts by weight of the total rubber in the rubber mixture.

The invention also provides rubber/steel cord composite vulcanates produced from the rubber mixtures according to the present invention, especially steel-cord-reinforced tires and technical rubber articles.

Preference is given to adhesive rubber mixtures according to the present invention that contain at least one solution rubber having a content of bonded hydroxyl and/or carboxyl groups or their salts of, in total, from 0.1 to 3 wt. %, especially from 0.1 to 1.5 %, and a content of vinylaromatic monomers polymerized therein of from 0 to 40 wt. %, especially from 10 to 40 wt. %, and a content of diolefins of from 99.9 to 60 wt. %, the content of 1,2-bonded diolefins (vinyl content) being in the range from 5 to 55 wt. % and the content of trans-1,4-bonded diolefin being in the range from 0 to 30 wt. %.

Preferred adhesive rubber mixtures according to the present invention also contain a content of from 3 to 10 parts by weight of sulfur, based on 100 parts by weight of rubber.

The amount of fillers is preferably from 10 to 250 parts by weight.

The diolefins used according to the present invention for the polymerization are 1,3-butadiene, isoprene, 1,3-pentadiene, 2,3-dimethylbutadiene, 1-vinyl-1,3-butadiene and/or 1,3-hexadiene. Special preference is given to the use of 1,3-butadiene and isoprene.

Examples of vinylaromatic monomers that may be used for polymerization may be styrene, o-, n- and p-methylstyrene, p-tert-butylstyrene, α-methylstyrene, vinylnaphthalene, divinylbenzene, trivinylbenzene and/or divinylnaphthalene. More preference is given to the use of styrene.

The rubbers based on diolefins and, optionally, further vinylaromatic monomers that are to be used according to the present invention in the rubber mixtures have average molecular weights (number average) of from 50,000 to 2,000,000, preferably from 100,000 to 1,000,000, and glass transition temperatures of from −110° C. to +20° C., preferably from −100° C. to 0° C., and Mooney viscosities ML 1+4 (100° C.) of from 10 to 200, preferably from 30 to 150.

In addition to the hydroxyl and carboxylic acid groups or their salts, the rubbers according to the present invention may also possess further known functional groups, such as carboxylic acid ester, carboxylic acid amide or sulfonic acid groups.

Special preference is given to solution rubbers containing hydroxyl and carboxyl groups, especially those as described in the above-mentioned European patent applications EP-A 974,616 and EP-A 1,000,971 as well as in DE-A 2,653,144 and EP-A 464,478.

For crosslinking, sulfur and/or sulfur donors in the indicated amounts are used. In this context, the term sulfur donors is to be understood as meaning sulfur-containing compounds that liberate sulfur for crosslinking under the mixing or vulcanization conditions, for example dithiodimorpholine, dicaprolactam disulfide or bis-(triethoxysilylpropyl) tetrasulfide.

The adhesive rubber mixtures according to the present invention are suitable for the production of composite vulcanates with all known steel cords. Preferred steel cords carry a brass outer layer or have been galvanized.

In an especially preferred embodiment, the rubber mixtures according to the present invention contain further known steel cord adhesives, such as, for example, silica/resorcinol/hexamethylenetetramine, melamine methylol ether, cobalt salts, especially cobalt naphthenate, nickel salts and/or boric acid esters. See in this respect DE-A 4,118,180, Rubber Chem. Technol. 1991, 64(2), 285-295, Ullmann, Encyklopädie der technischen Chemie, Verlag Chemie, Weinheim 1977, Volume 13, page 662-664, and Kautschuk, Gummi, Kunstst. 1990, 43(5), 385-387. The amounts of adhesives are approximately from 0.01 to 20 parts by weight, preferably from 0.1 to 10 parts by weight, based on 100 parts by weight of rubber.

Fillers for the rubber mixtures according to the present invention are all known fillers used in the rubber industry; they include both active and inactive fillers.

Mention may be made of:

highly dispersed silicas, prepared, for example, by precipitation of solutions of silicates or by flame hydrolysis of silicon halides, having specific surface areas of from 5 to 1000 m²/g, preferably from 20 to 400 m²/g (BET surface area) and having primary particle sizes of from 10 to 400 nm. The silicas may optionally be present also in the form of mixed oxides with other metal oxides, such as Al, Mg, Ca, Ba, Zn, Zr, Ti oxides;

synthetic silicates, such as aluminum silicate, alkaline earth metal silicate, such as magnesium silicate or calcium silicate, having BET surface areas of from 20 to 400 m²/g and primary particle diameters of from 10 to 400 nm;

natural silicates, such as kaolin and other naturally occurring silica;

glass fibers and glass fiber products (mats, strands) or glass microspheres;

metal oxides, such as zinc oxide, calcium oxide, magnesium oxide, aluminum oxide;

metal carbonates, such as magnesium carbonate, calcium carbonate, zinc carbonate;

metal hydroxides, such as, for example, aluminum hydroxide, magnesium hydroxide;

carbon blacks. The carbon blacks to be used are prepared by the flame carbon black, the furnace or the gas carbon black process and have BET surface areas of from 20 to 200 m²/g, e.g. SAF, ISAF, HAF, FEF or GPF carbon blacks;

rubber gels;

rubber powder, which has been obtained, for example, by milling rubber vulcanates.

Highly dispersed silicas and/or carbon blacks are preferably used as fillers.

The mentioned fillers may be used alone or in a mixture. In an especially preferred embodiment, the rubber mixtures contain as fillers a mixture of light fillers, such as highly dispersed silicas, and carbon blacks, the mixing ratio of light fillers to carbon blacks being 0.05 to 20, preferably 0.1 to 10.

In addition to the mentioned hydroxyl- and carboxyl-group-containing solution rubbers, the rubber mixtures according to the present invention may also contain other rubbers, such as natural rubber as well as other synthetic rubbers.

Preferred synthetic rubbers are described, for example, in W. Hofmann, Kautschuktechnologie, GentnerVerlag, Stuttgart 1980 and 1. Franta, Elastomers and Rubber Compounding Materials, Elsevier, Amsterdam 1989. They include inter alia:

| | |
|---|---|
| BR - | polybutadiene |
| ABR - | butadiene/acrylic acid C₁₋₄ alkyl ester copolymers |
| CR - | polychloroprene |
| IR - | polyisoprene |
| SBR - | styrene/butadiene copolymers having styrene contents of |
| | from 1 to 60 wt. %, preferably from 20 to 50 wt. % |
| IIR - | isobutylene/isoprene copolymers |
| NBR - | butadiene/acrylonitrile copolymers having acrylonitrile |
| | contents of from 5 to 60 wt. %, preferably from 10 to 40 wt. % |
| HNBR - | partially hydrogenated or fully hydrogenated NBR rubber |
| EPDM - | ethylene/propylene/diene copolymers |

as well as mixtures of those rubbers. For the production of steel-cord-reinforced motor vehicle tire mixtures, there are, of value, especially natural rubber, polyisoprene, emulsion SBR and solution SBR rubbers having a glass transition temperature above −50° C., polybutadiene rubber having a high 1,4-cis content (>90%) that has been prepared using Ni-, Co-, Ti- or Nd-based catalysts, as well as polybutadiene rubber having a vinyl content of up to 75%, and mixtures thereof.

Of course, the rubber mixtures according to the present invention may also contain other rubber auxiliaries that, for example, improve the physical properties of the rubber mixtures according to the present invention and of the vulcanates produced therefrom for their particular purpose.

Such rubber auxiliaries are, for example, the known reaction accelerators, anti-aging agents, heat stabilizers, light stabilizers, anti-ozonants, processing aids, reinforcing resins, for example, phenolic resins, steel cord adhesives, such as, for example, silica/resorcinol/hexa-methylenetetramine, boric acid esters or cobalt salts, such as, for example, Co naphthenate, plasticizers, tackifiers, blowing agents, colorings, pigments, waxes, extenders, organic acids, retardants, metal oxides and activators.

The rubber auxiliaries according to the present invention are used in the conventional, known amounts, the amount that is employed being dependent on the subsequent intended use of the rubber mixtures.

Amounts of rubber auxiliaries in the range of, for example, from 2 to 70 parts by weight, based on 100 parts by weight of rubber, are usual.

As mentioned above, additional rubbers may be added to the rubber mixtures according to the present invention in addition to the hydroxyl- and carboxyl-group-containing solution rubber. The amount of such additional rubbers is usually in the range from 10 to 95 wt. %, preferably from 30 to 90 wt. %, based on the total amount of rubber in the rubber mixture. The amount of additionally added rubbers is again dependent on the particular intended use of the rubber mixtures according to the present invention. Preference is given to rubber mixtures that contain, in addition to solution rubber, also from 30 to 90 parts by weight, preferably from 50 to 80 parts by weight, of natural rubber, based on 100 parts by weight of the total rubber.

For rubber mixtures according to the present invention that are filled with highly active silicas, the use of additional filler activators is especially advantageous. Preferred filler activators are sulfur-containing silyl ethers, especially bis-(trialkoxysilyl-alkyl) polysulfides, as are described in DE-A 2 141 159 and DE-A 2 255 577. Also suitable are oligomeric and/or polymeric sulfur-containing silyl ethers according to the description in DE-A 4 435 311 and EP-A 670 347. There may also be used mercaptoalkyltrialkoxysilanes, especially mercaptopropyltriethoxysilane, and thiocyanatoalkyl silyl ethers (see DE-A 19 544 469) and amino-group-containing silyl ethers, such as, for example, 3-aminopropyltriethoxysilane and N-oleyl-N-propyltrimethoxysilane. The filler activators are used in conventional amounts, that is to say in amounts of from 0.1 to 15 parts by weight, based on 100 parts by weight of rubber.

The rubber mixtures according to the present invention may be prepared, for example, by mixing the hydroxyl- and carboxyl-group-containing solution rubbers with the appropriate fillers and sulfur or sulfur donors in suitable mixing apparatuses, such as kneaders, rollers or extruders.

### EXAMPLES

### Example 1

### Hydroxyl-group-containing Solution SBR Rubber

0.63 kg of mercaptoethanol and 0.09 kg of dilauroyl peroxide were added at 80° C. to a solution of 45 kg of Buna VSL 5020-0 (solution SBR rubber having a styrene content of 20 wt. %, a vinyl content of 50 wt. %, a trans-1,4 content of 19%, manufacturer: Bayer AG) in 275 kg of cyclohexane, and stirring was carried out for 2 hours at 80° C. 0.23 kg of Vulkanox 4020 (type 6-PPD stabilizer, manufacturer: Bayer AG) was then added, and the solvent was removed by stripping with water vapor. Drying at 70° C. in vacuo yielded a solution SBR rubber having a hydroxyl group content of 0.3 wt. %, a trans-1,4 content of 19%, a glass transition temperature of −29° C. and a viscosity ML 1+4: 102.

### Example 2

### Carboxyl-group-containing Solution SBR Rubber

0.324 kg of 3-mercaptopropionic acid and 0.036 kg of dilauroyl peroxide were added at 80° C. to a solution of 45 kg of Buna VSL 5020-0 (solution SBR rubber having a styrene content of 20 wt. %, a vinyl content of 50 wt. %, a trans-1,4 content of 19%, manufacturer: Bayer AG) in 275 kg of cyclohexane, and stirring was carried out for 2 hours at 80° C. 0.23 kg of Vulkanox 4020 (type 6-PPD stabilizer, manufacturer: Bayer AG) was then added, and the solvent was removed by stripping with water vapor. Drying at 70° C. in vacuo yielded a solution SBR rubber having a carboxyl group content of 0.3 wt. %, a trans-1,4 content of 19%, an acid number of 5, a glass transition temperature of -29° C and a viscosity ML 1+4 (100° C.) of 65.

### Examples 3-8

### Rubber Mixtures

The rubber mixtures were prepared in a 1.5 liter internal mixer at 130-140° C. Finally, accelerator, sulfur and Cohedur Hexa were added on a roller at 50° C.:

| | Comparison | Example | Example | Example | Comparison | Example | Example |
|---|---|---|---|---|---|---|---|
| Component | 3 | 4 | 5 | 6 | 3.B | 7 | 8 |
| The following were mixed in an internal | | | | | | | |
| mixer: | | | | | | | |
| Natural rubber TSR 5, Defo 700 | 70 | 70 | 70 | 70 | 70 | 70 | 70 |
| Solution SBR Buna VSL 5020-0 | 30 | 0 | 0 | 0 | 30 | 0 | 0 |
| (Bayer AG) | | | | | | | |
| Solution SBR containing 0.3 wt. % OH | 0 | 30 | 0 | 0 | 0 | 30 | 0 |
| according to Example 1 | | | | | | | |
| Solution SBR containing 0.3 wt. % | 0 | 0 | 30 | 30 | 0 | 0 | 30 |
| COOH according to Example 2 | | | | | | | |
| Co naphthenate (8% Co) | 1.25 | 1.25 | 1.25 | 0 | 0 | 0 | 0 |
| Cohedur RS (Bayer AG) | 0 | 0 | 0 | 0 | 3.4 | 3.4 | 3.4 |
| Carbon black Corax N 326 | 55 | 55 | 55 | 55 | 50 | 50 | 50 |
| (Degussa-Hüls AG) | | | | | | | |
| Silica Vulkasil S (Bayer AG) | 0 | 0 | 0 | 0 | 15 | 15 | 15 |
| Aromatic mineral oil Mobilsol K (Mobil) | 4 | 4 | 4 | 4 | 4 | 4 | 4 |
| Phenolic resin Koresin (BASF) | 4 | 4 | 4 | 4 | 4 | 4 | 4 |
| Zinc oxide | 8 | 8 | 8 | 8 | 8 | 8 | 8 |
| Anti-aging agent | 2 | 2 | 2 | 2 | 2 | 2 | 2 |
| Vulkanox HS (Bayer AG) | | | | | | | |
| Stearic acid | 1 | 1 | 1 | 1 | 0 | 0 | 0 |
| The following were added on a roller: | | | | | | | |
| Cohedur Hexa (Bayer AG) | 0 | 0 | 0 | 0 | 1.5 | 1.5 | 1.5 |
| N-Dicyclohexyl- | 0.7 | 0.7 | 0.7 | 0.7 | 0.7 | 0.7 | 0.7 |
| mercaptobenzthiazolesulfenamide | | | | | | | |
| Vulkacit DZ (Bayer AG) | | | | | | | |
| Sulfur | 4 | 4 | 4 | 4 | 4 | 4 | 4 |
| Viscosity of the mixture ML 1 + 4 | 42 | 56 | 58 | 51 | 64 | 81 | 72 |
| (100° C.) | | | | | | | |
| The mixtures were vulcanized at | | | | | | | |
| 150° C. for 25 min. | | | | | | | |
| Vulcanate properties: | | | | | | | |
| Tensile strength (MPa) | 23.1 | 26.4 | 25.9 | 26.4 | 22.1 | 25.9 | 25.8 |
| Ultimate elongation (%) | 510 | 470 | 490 | 510 | 510 | 420 | 440 |
| Tensile stress at 300% elongation | 13.4 | 15.3 | 15.2 | 16.1 | 11.1 | 17.7 | 18.1 |
| (MPa) | | | | | | | |
| Tear-growth resistance DIN 53515 | 42 | 53 | 52 | 72 | 45 | 68 | 65 |
| (N/mm) | | | | | | | |
| Shore A hardness | 70 | 72 | 71 | 72 | 64 | 75 | 75 |
| Rebound resilience at 23° C. (%) | 38 | 34 | 35 | 33 | 31 | 34 | 35 |
| Rebound resilience at 70° C. (%) | 52 | 54 | 55 | 56 | 47 | 49 | 49 |
| Cord thread adhesion, without aging | 590 | 750 | 730 | 680 | 550 | 880 | 830 |
| (N/20 mm) | | | | | | | |
| Cord thread adhesion after 7 days | 660 | 820 | 810 | 760 | 620 | 1080 | 1020 |
| 100° C. (N/20 mm) | | | | | | | |
| Cord thread adhesion after 2 days | 510 | 720 | 690 | 570 | 430 | 590 | 620 |
| 120° C. water vapor | | | | | | | |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. Adhesive rubber mixtures for the production of rubber/steel cord composite vulcanates, comprising
a) at least one rubber, wherein said rubber is prepared by polymerizing diolefins and, optionally, further vinylaromatic monomers in solution and introducing hydroxyl and/or carboxyl groups, said rubber having a total content of from 0.05 to 5 wt. % of bonded hydroxyl and/or carboxyl groups or their salts, a content of vinylaromatic monomers polymerized therein of from 0 to 50 wt. % and a content of diolefins of from 45 to 99.95 wt. %, the content of 1,2-bonded diolefins (vinyl content) being from 0 to 60 wt. % and the content of trans-1,4-bonded diolefin being from 0 to 40 wt. %, from 2 to 20 parts by weight of sulfur or sulfur donors;
b) from 5 to 300 parts by weight of filler;
c) and, optionally, further rubbers, rubber auxiliaries and crosslinking agents, the indicated parts by weight of filler and sulfur being based on 100 parts by weight of the total rubber in the rubber mixture.

2. Adhesive rubber mixtures according to claim 1, wherein said mixtures comprise at least one solution rubber having a content of bonded hydroxyl and/or carboxyl groups or their salts of, in total, from 0.1 to 3 wt. %, and a content of vinylaromatic monomers polymerized therein of from 0 to 40 wt. %, and a content of diolefins of from 99.9 to 60 wt. %, the content of 1,2-bonded diolefins (vinyl content) being in the range from 5 to 55 wt. % and the content of trans-1,4-bonded diolefin being in the range from 0 to 30 wt. %.

3. Adhesive rubber mixtures according to claim 2, wherein said mixtures comprise at least one solution rubber having a content of bonded hydroxyl and/or carboxyl groups or their salts of, in total from 0.1 to 1.5% a content of vinylaromatic monomers polymerized therein of from 10 to 40 wt. %.

4. Adhesive rubber mixtures according to claim 2, wherein said mixtures comprise a content of from 3 to 10 parts by weight of sulfur, based on 100 parts by weight of the total rubber in the rubber mixture.

5. Adhesive rubber mixtures according to claim 1, wherein said mixture comprises, in addition to the hydroxyl- and/or carboxyl-group-containing solution rubbers, from 30 to 90 parts by weight of natural rubber, based on 100 parts by weight of the total rubber.

6. Rubber/steel cord composite vulcanates comprising adhesive rubbers, which comprises
a) at least one rubber, wherein said rubber is prepared by polymerizing diolefins and, optionally, further vinylaromatic monomers in solution and introducing hydroxyl and/or carboxyl groups, said rubber having a total content of from 0.05 to 5 wt. % of bonded hydroxyl and/or carboxyl groups or their salts, a content of vinylaromatic monomers polymerized therein of from 0 to 50 wt. % and a content of diolefins of from 45 to 99.95 wt. %, the content of 1,2-bonded diolefins (vinyl content) being from 0 to 60 wt. % and the content of trans-1,4-bonded diolefin being from 0 to 40 wt. %, from 2 to 20 parts by weight of sulfur or sulfur donors;
b) from 5 to 300 parts by weight of filler; and
c) optionally, further rubbers, rubber auxiliaries and crosslinking agents, the indicated parts by weight of filler and sulfur being based on 100 parts by weight of the total rubber in the rubber mixture.

7. Rubber/steel cord composite vulcanates according to claim 6, wherein said vulcanates is a steel-cord-reinforced tires.
